(19) United States
(12) Patent Application Publication
(10) Pub. No.: US 2015/0302609 A1
(43) Pub. Date: Oct. 22, 2015

(54) METHOD AND APPARATUS FOR SPECTRAL ENHANCEMENT USING MACHINE VISION FOR COLOR/OBJECT RECOGNITION

(71) Applicant: GE Lighting Solutions, LLC, East Cleveland, OH (US)

(72) Inventor: Anthony Michael ROTELLA, Cleveland, OH (US)

(73) Assignee: GE Lighting Solutions, LLC, East Cleveland, OH (US)

(21) Appl. No.: 14/253,889

(22) Filed: Apr. 16, 2014

(51) Int. Cl. G06T 7/40; G06K 9/46; H05B 33/08; H04N 7/18

(52) U.S. Cl. CPC G06T 7/408; H04N 7/18; G06K 9/4652; G06K 9/4661; H05B 33/0872

(57) ABSTRACT

A lighting apparatus includes a vision system configured to receive light from a scene and produce a digital image; a controller coupled to the vision system and configured to receive the digital image and produce a plurality of color signals; a driver coupled to the controller and configured to receive the plurality of color signals and produce a plurality of drive signals; and a lamp assembly coupled to the driver and configured to receive the plurality of drive signals and produce light having a color spectrum corresponding to the plurality of drive signals. The controller is configured to derive color information from the digital image and adjust the color signals based at least in part on the derived color information.

### BACKGROUND

1. Field

The aspects of the present disclosure relate generally to spectral enhanced lighting apparatus and in particular to spectral control of lighting apparatus using machine vision.

2. Description of Related Art

It is well known that tailoring of color spectra when lighting a scene can significantly alter the way a scene is perceived by the human eye and that different color spectra can evoke different emotions in a viewer. Theatre lighting provides a good example. Tailoring of color spectra to achieve a desired effect has become common practice in many industries and is finding increased popularity in homes and offices as well. Retailers may use lighting with increased blue and violet light or color content to improve the attractiveness of clothing displays, while grocers may want increased green light or color content for produce, increased red light or color content for meats, and warmer light and color content for baked goods. Lighting manufacturers are responding to this need by providing new low cost lighting products with tailored color spectra designed to improve the attractiveness of retail displays or augment the attractiveness or feeling of comfort of a home.

For example, some of these products create more vibrant reds and greens by at least partially removing the yellow color content of the lamps. However, since no single lamp can provide all of the different color spectra, lighting suppliers need to manufacture and stock a wide variety of lamps for the various purposes. End users are limited to only those spectra made available by the suppliers.

Over the past several years, digital camera devices have become widely available and are very low cost. These devices convert light coming from a scene into a digital image, which is an array of digital or binary values. Each value, referred to as a pixel, corresponds to the light coming from a particular point in the scene being photographed. It is typical for sensors of a digital camera to measure the red, green, and blue content at each pixel and convert the content to a set of binary values representing the intensity of each color component. The binary values are often 8 bits in length providing 255 different levels; however binary values with larger or smaller bit lengths are also common. This color system is known as a red-green-blue or RGB color model. In addition to the RGB model other color models have become popular for various digital image processing purposes. One common model is the hue, saturation, value (HSV) model, also known as hue, saturation, brightness (HSB).

The RGB model is an additive color model where the color of each pixel is represented by three values corresponding to each of the primary colors red, green and blue. The RGB model can be represented using a Cartesian coordinate system where the intensity of each color is represented as distance along one of the three axes. The HSV model is a cylindrical coordinate representation of points in an RGB color model where the angle around the central axis corresponds to hue, the distance from the axis corresponds to saturation, and distance along the axis corresponds to value. The HSV model is a simple transformation of points in the RGB model and provides many advantages when analyzing and processing the image.

A light emitting diode (LED) is an electric light source constructed from semiconductor materials such as gallium arsenide or organic compounds. When electric current is passed through a LED, electrons recombine with holes within a junction area releasing energy in the form of photons. LED lighting devices have become popular due to their energy efficiency, long life, and the wide range of color spectra available. Various lighting devices have been created using LED technology that have multiple individually controllable LED elements, where each element generates a different color spectrum. A traffic light is an example of one such device that can include a yellow, red, and green element.

Each LED element can be physically separate from the other elements, as is the case in a traffic light. Alternatively, the LEDs of each element can be comingled such as is done with the red, green, and blue elements of a television screen. It is also common to create multi-element lighting devices with individually controllable elements having varying color spectra by using lighting technologies other than LED devices.

The problem of providing correct lighting depending on the scene is still a relevant problem today, especially in the commercial channels. Retailers are highly specific and demanding when it comes to their lightning, and lighting companies typically have to offer a wide array of possible solutions and products in order to ensure customer satisfaction. Even today, LED manufacturers are offering separate LED solutions for products used in food display lighting, such as where one lamp is used for produce and a different lamp for meat. Still, different solutions are needed to satisfy the requirements of various environments and applications, such as for example, art museums, clothing stores, grocery stores, retail spaces and commercial establishments.

Accordingly, it would be desirable to provide a spectral enhancing light source that can satisfy the spectral needs of multiple applications with a single lighting solution.

### BRIEF DESCRIPTION OF THE DISCLOSED EMBODIMENTS

As described herein, the exemplary embodiments overcome one or more of the above or other disadvantages known in the art.

One aspect of the exemplary embodiments relates to a lighting apparatus. In one embodiment, the lighting apparatus includes a vision system configured to receive light from a scene and produce a digital image; a controller coupled to the vision system and configured to receive the digital image and produce a plurality of color signals; a driver coupled to the controller and configured to receive the plurality of color signals and produce a plurality of drive signals; and a lamp assembly coupled to the driver and configured to receive the plurality of drive signals and produce light having a color spectrum corresponding to the plurality of drive signals. The controller is configured to derive color information from the digital image and adjust the color signals based at least in part on the derived color information.

Another aspect of the exemplary embodiments relates to a method for spectral enhancement of a scene. In one embodiment the method includes capturing a digital image of a scene, analyzing the digital image to determine color content, determining a desired color spectrum based at least in part on the determined color content, operating a lamp assembly to produce the desired color spectrum, and illuminating the scene with the lamp assembly.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

In the drawings:

FIG. 1 illustrates one embodiment of an exemplary architecture for a lighting apparatus incorporating aspects of the present disclosure.

FIG. 2 illustrates an exemplary algorithm for analyzing color content of a digital image incorporating aspects of the disclosed embodiments.

FIG. 3 illustrates a hue histogram resulting from a binning operation incorporating aspects of the present disclosure.

FIG. 4 illustrates a flow chart of an exemplary method for augmenting the color spectrum of a scene incorporating aspects of the disclosed embodiments.

### DETAILED DESCRIPTION OF THE DISCLOSED EMBODIMENTS

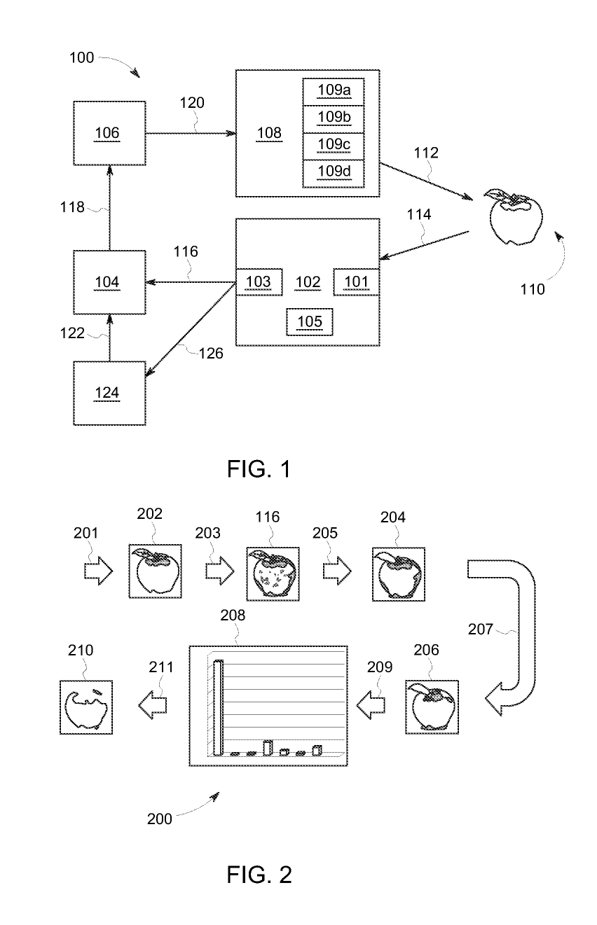

Referring now to FIG. 1 there can be seen an architecture for a lighting apparatus 100 capable of enhancing the color spectrum of a scene 110 being illuminated. The lighting apparatus 100 is adapted to monitor and analyze light 114 coming from the scene 110 and enhance the color spectrum of light 112 produced or emitted by a lamp assembly 108 to achieve a desired effect. Lighting apparatus 100 may be advantageously employed to augment lighting for a variety of scenes 110, including for example grocery store displays, retail displays, homes, or offices. In alternate embodiments, the lighting apparatus 100 of the present disclosure can be employed for any suitable scene 110 where it is desirable to enhance the color spectrum of the emitted light 112 used to illuminate them.

As is illustrated in FIG. 1, the emitted light 112 is produced by the lamp assembly 108. The lamp assembly 108 is configured to allow adjustment of the color spectrum of the emitted light 112. In one embodiment, the lamp assembly 108 includes several individually controllable lamp elements 109a, 109b, 109c, and 109d where each lamp element 109a, 109b, 109c, and 109d includes one or more light emitting diodes (LEDs) and is configured to produce light with a desired color spectrum. By constructing the lamp elements 109a, 109b, 109c, and 109d to have different color spectra and driving each lamp element at a different power level, the color spectrum of emitted light 112 can be modified in a predictable fashion. For example, in one embodiment, the lamp assembly 108 can be constructed to have a red lamp element 109a, a green lamp element 109b, a blue lamp element 109c, and a white lamp element 109d, resulting in a four lamp element assembly. In alternate embodiments, any suitable combination of lamp elements 109a, 109b, 109c, and 109d can be used, including lamp assemblies with more or less than four lamp elements. This type of four lamp element assembly, referred to as a RGB plus White light source, can be used in a variety of applications where it is desirable to ensure high color rendering or dramatic lighting. Examples of these applications can include, but are not limited to, retail and commercial goods and environments, like clothing, grocery, or furniture.

Lamp assembly 108 illustrates an embodiment where each lamp element 109a, 109b, 109c, and 109d is physically separate. In alternate embodiments the individual LEDs of each lamp element 109a, 109b, 109c, and 109d may be comingled.

Another example of an application where the lighting apparatus 100 of FIG. 1 could be applied is in art displays, where color and lighting is one of the most important characteristics. In this embodiment, the lamp assembly 108 can have more or less than four lamp elements 109a, 109b, 109c, and 109d or be constructed based on different light source technologies where the lamp elements 109a, 109b, 109c, and 109d have various color spectra allowing production of emitted light 112 having a desired color spectrum. For example, in certain applications, it can be advantageous to include different lamp elements 109a, 109b, 109c, and 109d such as a warm white light with a correlated color temperature (CCT) around 3000 degrees Kelvin (K) or a cool white light around 5000 K. CCT. Alternatively, the lamp assembly 108 can include lamp elements 109a, 109b, 109c, and 109d with primary colors, white light, or other color spectra as necessary to create emitted light 112 with a desired color spectrum.

In one embodiment, a vision system 102 is used to capture a digital image of the scene 110. The vision system 102 can comprise a machine vision system and may include a video camera or a still camera capable of sensing light in the visible or near visible portion of the electromagnetic spectrum, such as wavelengths between about 380 nanometers (nm) to about 750 nm. Vision system 102 belongs to a category of sensing technologies often referred to as Machine vision. Machine vision has noticeable advantages over other sensing technologies such as infrared, proximity, ultrasonic, etc. One of the most important advantages provided by machine vision is the relatively large amount of information that can be attained, and the ability to smooth and manipulate the gathered information using sophisticated algorithms to create more intelligent, robust, and advanced lighting systems.

In one embodiment, the vision system 102 may include a sensing element 101, and electronics 103 in conjunction with an optional processing device 105. The vision system 102 is configured to capture one or more digital images 116 of the scene 110. In alternate embodiments, the vision system 102 can include any suitable components for capturing the digital image 116 of the scene 110. The term “digital image” as used herein generally refers to an array of digital or binary values used to represent a two (or three) dimensional image of a scene, where each value in the digital image, referred to as a pixel, is composed of one or more values and corresponds to a particular point in the scene 110, and represents the light coming from that point on the scene. The vision system 102 produces a color digital image using a RGB color model where each pixel in the digital image has three components; a red, a green, and a blue color value. This RGB digital image is then converted to an HSV digital image representation 116. Alternatively, the vision system 102 can be configured to create the digital image using any suitable color model then convert to a HSV model or the vision system 102 can create the digital image directly in a HSV model thereby bypassing the conversion step.

In the embodiment illustrated in FIG. 1, a controller 104 receives the digital image 116 and converts it to a set of color signals 118 where each color signal corresponds to a desired drive power for a lamp element 109a, 109b, 109c, or 109d of the lamp assembly 108. In the embodiment of the architecture of the lighting apparatus 100 shown in FIG. 1, the lighting apparatus 100 illustrates the controller 104 as being a separate component from, and coupled to the vision system 102. However, this separation is presented merely as an aid to understanding the architecture and those skilled in the art will recognize that the both the controller 104 and the vision system 102 may be combined into a single processing device or distributed among many processing devices. In such an embodiment, the processing steps performed by the vision system 102 can be performed by the same processing device as the steps performed by the controller 104 without straying from the spirit and scope of the present disclosure.

As will be discussed further below, the controller 104 analyzes color information contained in the digital image 116 and uses it to produce the plurality of color signals 118 that will control the intensity of lighting elements in the lamp assembly 108. The plurality of color signals 118 is received by a multi-channel driver 106 that converts the color signals 118 into a corresponding plurality of drive signals 120. The power level of each drive signal 120 corresponds to a color signal 118 and each drive signal 120 is adapted to power a separate lamp element 109a, 109b, 109c, and 109d of the lamp assembly 108.

The vision system 102 and the controller 104 contain one or more processing devices. Alternatively both the vision system 102 and controller 104 can use the same processing device. The term “processing device” as used herein refers to any general purpose computer comprising components such as one or more central processing units (CPU), main memory, input/output devices, external storage, etc. as is well known in the art, e.g. a personal computer (PC), a laptop, a mainframe computer, a server type computer, a microprocessor, etc. A processing device may also be implemented using for example specialized digital hardware such as field programmable logic arrays (FPLA), discrete digital components, microprocessors with mask programmed read only memory (ROM), etc. A processing device can also be any combination of general purpose computing devices and dedicated digital hardware capable of executing machine-readable instructions, or operating on digital signals. The specific implementation of the processing device is not germane to operation of the lighting apparatus disclosed herein.

In the lighting apparatus 100 described above, a digital image 116 is captured in the vision system 102 then analyzed in the controller 104 to determine color content. FIG. 2 illustrates one example of an algorithm 200 that may be used to analyze color content of a digital image 116. The algorithm begins by using a vision system 102 to capture 201 a digital image 202 of a scene 110. The digital image 202 is captured 201 in an RGB color model or other suitable color model then converted 203 to a HSV digital image 116. A HSV digital image is a digital image represented using the HSV color model. Alternatively, the digital image 202 can be captured 201 in the HSV representation 116 directly thereby eliminating the initial conversion 203. Representing an image using a HSV color model is advantageous for color spectra adjustment because it isolates color in one channel independent of other effects of lighting. Using the hue channel alone for analysis allows filtering of shine, and shadows as well as other lighting effects, and facilitates binning individual pixels by color.

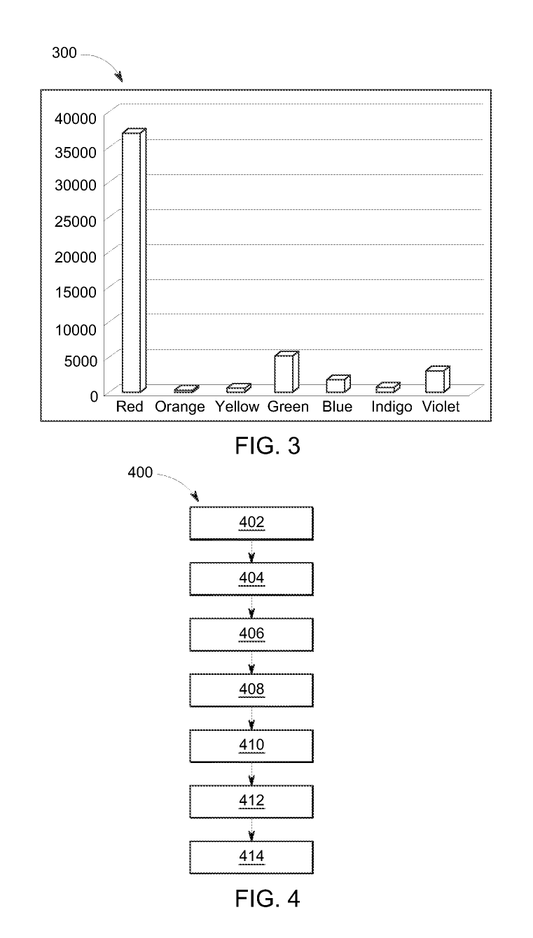

Once a HSV digital image 116 is obtained either directly or by transforming 203 an RGB digital image 202, preprocessing 205 is done to create an enhanced digital image 204. During this processing 205, prominent objects can be identified and other filtering and enhancement operations can be used to prepare the digital image 204 for color analysis. Next, the hue channel of the enhanced digital image 204 is isolated 207 resulting in a digital image 206 containing only color information with other lighting effects removed. Each pixel of the digital image 206 is binned by hue, sorted, and tallied, and the image is masked such that only objects in these colors remain. The result of this operation can be represented 209 as a hue histogram 208 which will be described further below with reference to FIG. 3.

As shown in the example of FIG. 3, each bin corresponds to a range of hue values and the number of pixels in each bin provides information about the amount or intensity of color in each color range in the digital image 206. In one embodiment, the output 210 of the algorithm 200 provides information about the dominant or prominent colors in the original digital image 202, which can then be used to determine a desired color spectrum with which to illuminate a scene. In the example of FIG. 2, the exemplary digital image 202 is a red apple. For this digital image 202, the output 210 of the algorithm 200 would be the prominence of red in the image 202.

FIG. 3 shows a hue histogram 300 that can be created to illustrate the result of the binning and sorting operation of the image processing algorithm 200. The color bins, which in this example are red, orange, yellow, green, blue, indigo, and violet, are listed along the horizontal axis and the number of pixels is plotted as distance along the vertical axis. The hue histogram 300 shows a strong presence of the red color as would be expected in the digital image of an apple. The number of hue ranges or bins, and the width of each hue range, can vary from application to application and can be chosen as appropriate for the needs of each particular lighting application.

Designing the lighting apparatus 100 to conform to industry standard lamp form factors and use locally available grid power provides color enhancing lamps that can be easily retrofit into existing lighting applications. Grid power refers to the electric power available from the local electrical power grid and is also commonly referred to as mains power, mains electricity, or line voltage. For example, in the United States, grid power may be the 110 volt, 60 hertz power supplied through household electric outlets. Generally, the grid power may be any locally available power. For example, the lighting apparatus 100 could be contained in a package that conforms to a standard PAR38 or PAR30 flood lamp form factor or could be constructed as a standard fluorescent troffer replacement for use in ceiling fixtures. Constructing the lighting apparatus 100 in an industry standard form factor allows easy retrofitting of color enhancing lamps into existing lighting fixtures without the need for any modifications or installation of additional equipment. In certain embodiments the controller 104 would contain enough information to operate autonomously and could properly adjust its color spectrum by itself without any external input being required.

The lighting apparatus 100 can also be programmed to periodically capture a digital image 116, analyze its color content, and update the generated color spectrum to ensure that the spectrum remains current. For example, in a grocery store environment or application, a lighting apparatus 100 of the type described above can capture a digital image 116 and detect that the digital image 116 is one of produce, or more particularly, the type of produce, which for purposes of this example is spinach. The lighting apparatus 100 can be configured to automatically adjust its color spectrum to render green content corresponding to the spinach. If the lighting apparatus 100 is moved to a meat environment, and the detected digital image contains a prominence of meat, the lighting apparatus 100 can adjust its color spectrum to remove the green content, previously used in conjunction with the spinach, and adjust its color spectra to add red content for the meat. In certain embodiments a feature could be included where when the image or subject being illuminated is too complex or has a relatively even hue content across the color range, the controller 104 could simply choose to provide a high CRI, 2700-3000K CCT light that most people would find pleasing. A complex scene would be one where the objects of interest or color content in the scene cannot be reliably determined or the result of the analysis does not allow determination of enhanced color spectra.

In certain embodiments it is desirable to include a user input device 124 to enable user input 122 to the controller 104 to more efficiently augment the scene 110 being lighted. User input as used herein refers to information or other data received from a user of the device 124. In one embodiment the input device 124 can be a small rotary switch mounted on the side of a PAR30 or PAR38 flood lamp containing a lighting apparatus 100 incorporating the color enhancing architecture 100, which would allow a grocer to select the department where the flood lamp is being installed. In alternate embodiments, the input device 124 can comprise any suitable switch, such as an electronic or digital switch. Alternatively, in an art gallery environment, selections could be provided for other special lighting effects, such as when displays are changed.

In one embodiment, the user inputs 122 comprise a wireless or other type of computer interface to allow modification of the spectra selection algorithms used by the controller 104 while the lighting apparatus 100 remains in place. An input device 124 comprising a wireless interface would allow user inputs 122 to be provided remotely from off-site locations with an input device 124 comprising a wireless interface such as a cellular phone or tablet. The input device 124 could be configured to communicate over standard wireless networks such as WiFi, cellular, Bluetooth™, or other suitable wireless interfaces. Alternatively a proprietary wireless interface could be advantageously designed. In certain embodiments it is advantageous to configure input device 124 to include two way communications and to provide live feeds of captured images 126 from the vision system 102 to a remotely located input device 124. These captured images 126 could be used to aid selection of user inputs 122.

FIG. 4 illustrates a method 400 of using a lighting apparatus 100 to adjust the color spectrum of a lamp assembly 108 and augment colors in a scene 110 being lighted. In one embodiment, a digital image 116 of a scene 110 is captured 402 using a vision system 102 of the lighting apparatus 100. The digital image 116 is captured 402 using a digital camera or other suitable vision system 102 mounted within the lighting apparatus 100 capable of converting light from the scene 110 into the digital image 116. In one embodiment, a RGB digital image 202 can be captured 402 then transformed 404 to a HSV color model to produce a HSV digital image 116. The digital image 116 can then be noise corrected and enhanced 406 in various ways using known image processing techniques to produce an enhanced digital image 204. The pixels in the HSV digital image 116 are then binned by hue, sorted, and tallied, and the HSV digital image 116 is masked such that only objects in the colors of interest remain 408. The average hue of the remaining objects is then computed and sent 410 to a controller 104. The controller 104 applies spectral tailoring algorithms to the hue data to determine 412 values for a set of color drive signals 118. A multi-channel driver 106 is then used to receive the color drive signals 118 and adjusts 414 the lamp power in each lamp element 109a, 109b, 109c, or 109d of a multi-element lamp assembly 108 in accordance with the color drive signals 118. The method 400 can be used in a lighting apparatus, such as the lighting apparatus 100 described above, to autonomously adjust the color spectrum of light produced by the lighting apparatus to advantageously augment color rendering of a scene being lighted.

Thus, while there have been shown, described and pointed out, fundamental novel features of the invention as applied to the exemplary embodiments thereof, it will be understood that various omissions and substitutions and changes in the form and details of devices and methods illustrated, and in their operation, may be made by those skilled in the art without departing from the spirit and scope of the invention. Moreover, it is expressly intended that all combinations of those elements, which perform substantially the same function in substantially the same way to achieve the same results, are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A lighting apparatus comprising:
a vision system configured to receive light from a scene and produce a digital image;
a controller coupled to the vision system and configured to receive the digital image and produce a plurality of color signals;
a driver coupled to the controller and configured to receive the plurality of color signals and produce a plurality of drive signals; and
a lamp assembly coupled to the driver and configured to receive the plurality of drive signals and produce light having a color spectrum corresponding to the plurality of drive signals,
wherein the controller is configured to:
derive color information from the digital image;
determine a desired color spectrum based at least in part on the derived color information; and
adjust the plurality of color signals such that the desired color spectrum is produced by the lamp assembly.

2. The lighting apparatus of claim 1 wherein the digital image is represented in a HSV color model.

3. The lighting apparatus of claim 1 wherein the vision system is configured to produce the digital image in an RGB color model and transform the RGB color model of the digital image to an HSV color model.

4. The lighting apparatus of claim 1 wherein the digital image comprises pixels and the controller is configured to:
bin pixels by hue;
mask the digital image such that only objects of desired hues remain;
determine an average hue value of the remaining objects; and
adjust the plurality of color signals based at least in part on the average hue value.

5. The lighting apparatus of claim 1 wherein the lighting apparatus conforms to an industry standard form factor and is configured to operate on locally available power.

6. The lighting apparatus of claim 5 wherein the form factor comprises a PAR30 or PAR38 spot lamp.

7. The lighting apparatus of claim 5 wherein the form factor comprises that of a fluorescent troffer lamp.

8. The lighting apparatus of claim 1 wherein the lamp assembly comprises a plurality of LEDs.

9. The lighting apparatus of claim 8 wherein the lamp assembly comprises a plurality of separately controllable lamp elements, and wherein each lamp element produces light having different color spectra.

10. The lighting apparatus of claim 9 wherein the lamp assembly comprises a red element, a green element, a blue element, and a white element.

11. The lighting apparatus of claim 1 comprising an input device configured to receive user input wherein the controller is configured to adjust the color signals based at least in part on the received information.

12. The lighting apparatus of claim 1 comprising a computer interface configured to receive user input wherein the controller is configured to adjust the color signals based at least in part on the received user input.

13. The lighting apparatus of claim 12 wherein the computer interface comprises a wireless computer interface.

14. A method for spectral enhancement of a scene, the method comprising:
capturing a digital image of a scene;
analyzing the captured digital image to determine a color content of the captured digital image;
determining a desired color spectrum based at least in part on the determined color content;
operating a lamp assembly to produce the desired color spectrum; and
illuminating the scene with the lamp assembly.

15. The method of claim 14 wherein capturing the digital image comprises capturing the digital image using a RGB color model and transforming the digital image to a HSV color model.

16. The method of claim 14 wherein the digital image comprises pixels represented in a HSV color model, and
wherein analyzing the digital image comprises binning and sorting the pixels according to hue;

17. The method of claim 16 wherein analyzing the digital image further comprises creating an average hue value for the objects of interest in the digital image.

18. The method of claim 14 wherein determining a desired color spectrum comprises selecting a high CRI white light spectrum for complex scenes.

19. The method of claim 14 wherein determining a desired color spectrum comprises selecting a high CRI white light spectrum for scenes having relatively even hue content across the color range.
